(19) United States
(12) Patent Application Publication
(10) Pub. No.: US 2022/0256177 A1
(43) Pub. Date: Aug. 11, 2022

(54) ENCODING SYSTEM AND METHOD FOR DISPLAY STREAM COMPRESSION

(71) Applicant: Korea Electronics Technology Institute, Seongnam-si (KR)

(72) Inventors: Hee Tak KIM, Seongnam-si (KR); Byung Soo KIM, Yongin-si (KR); Young Jong JANG, Yongin-si (KR); Tae Ho HWANG, Yongin-si (KR)

(21) Appl. No.: 17/665,910

(22) Filed: Feb. 7, 2022

(30) Foreign Application Priority Data
Feb. 5, 2021 (KR) 10-2021-0016709

(51) Int. Cl. H04N 19/42; H04N 21/44

(52) U.S. Cl. CPC H04N 19/42; H04N 19/124; H04N 21/44004

(57) ABSTRACT

This application relates to a display stream compression (DSC) encoding method in a DSC encoding hardware device. In one aspect, the method may include applying a DSC encoding setting variable set by a core. The method may also include reading an input video, received through a video receiver, from an image buffer in which the input video is stored. The method may further include receiving a DSC encoding operation execution command from the core and executing a DSC encoding operation on the basis of the DSC encoding setting variable.

### CROSS-REFERENCE TO RELATED APPLICATION

The present application claims priority to Korean Patent Application No. 10-2021-0016709 filed on Feb. 5, 2021 in the Korean Intellectual Property Office, which is incorporated herein in its entirety by reference.

### BACKGROUND

### Technical Field

The present disclosure relates to an encoding system and method for DSC (Display Stream Compression).

### Description of Related Technology

Recently, as the trend of the display industry has changed from the 1080 p HDTV display to the high-resolution display with a resolution of 4 K or more, the bandwidth requirements have dramatically increased. Thus, the compression for display interfaces has become more necessary.

VESA (Video Electronics Standards Association) has developed a DSC algorithm capable of compressing an input image at 2:1 or 3:1 without image degradation, as the5 standard for display link video compression. The DSC algorithm has been adopted as the standard compression algorithm of display and HDMI ports.

### SUMMARY

Various embodiments are directed to an encoding system and method for DSC (Display Stream Compression), which can provide a DSC encoding hardware structure capable of compressing an input video at high speed, and supporting various inputs.

However, the problems to be solved by the present disclosure are not limited to the above-described problems, and other problems may be present.

In an embodiment, a DSC encoding method in a DSC encoding hardware device may include: applying a DSC encoding setting variable set by a core; reading an input video, received through a video receiver, from an image buffer in which the input video is stored; receiving a DSC encoding operation execution command from the core; and executing a DSC encoding operation on the basis of the DSC encoding setting variable.

The DSC encoding hardware device is connected to the core through an ABP interface.

A bit stream, outputted as the DSC encoding operation is completed, may be stored in a rate buffer, and a video transmitter may read the bit stream stored in the rate buffer, and output the read bit stream to a video device.

The DSC encoding hardware device may support one or more input modes among RGB, YUV, YUV-422 and YUV-420.

In an embodiment, a DSC encoding system may include: an image buffer configured to store an input video received through a video receiver; a core configured to set a DSC encoding setting variable; a DSC encoding hardware device configured to read the input video from the image buffer according to a DSC encoding operation execution command received from the core, and execute a DSC encoding operation on the basis of the DSC encoding setting variable, and a rate buffer configured to store the DSC encoding execution result.

The DSC encoding hardware device may be connected to the core through an ABP interface.

The rate buffer may store a bit stream which is outputted as the DSC encoding operation is completed, and a video transmitter may read the bit stream stored in the rate buffer, and output the read bit stream to a video device.

The DSC encoding hardware device may support one or more input modes among RGB, YUV, YUV-422 and YUV-420.

In addition, a computer-readable recording medium may be further provided, in which another method and another system for implementing the present disclosure and a computer program for executing the method are recorded.

In accordance with the embodiment of the present disclosure, it is possible to provide the DSC encoding hardware structure capable of compressing an input video at high speed and supporting various inputs.

The effects of the present disclosure are not limited to the above-mentioned effects, and the other effects which are not mentioned herein will be clearly understood from the following descriptions by those skilled in the art.

### BRIEF DESCRIPTION OF THE DRAWINGS

FIG. 1A and FIG. 1B are diagram illustrating a DSC algorithm published by the VESA.

FIG. 2 is a block diagram illustrating a DSC encoding system in accordance with an embodiment of the present disclosure.

FIG. 3A and FIG. 3B are block diagrams illustrating a DSC encoding hardware device.

FIGS. 4 and 5 are diagrams illustrating input/output timings of the DSC encoding hardware device.

FIG. 6 is a flowchart illustrating a DSC encoding method in accordance with an embodiment of the present disclosure.

### DETAILED DESCRIPTION

The DSC standard is a video compression standard capable of compressing video in order to transmit the video through display links. With the increase in resolutions of displays, the bandwidth of video data required for driving the displays also increases. Some display links may not have a bandwidth capable of transmitting all video data with such resolutions to a display. Therefore, the DSC standard defines a compression standard for compression without visual loss, which is available through display links.

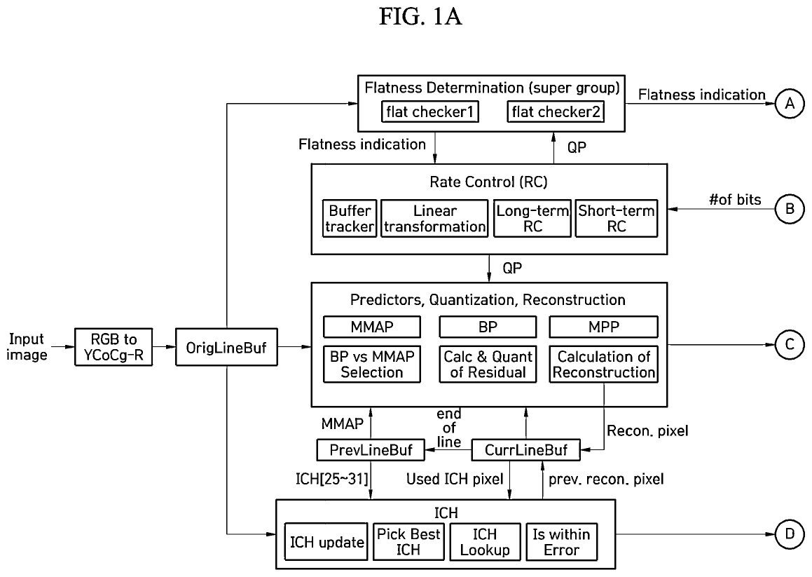

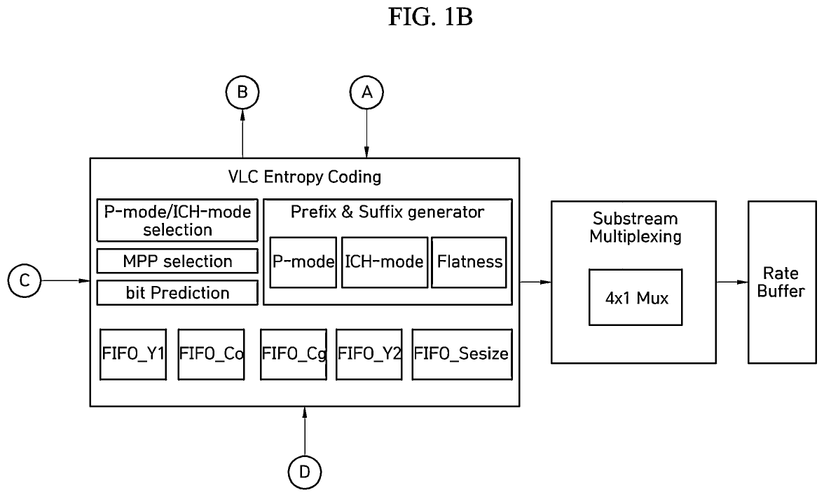

FIG. 1A and FIG. 1B are diagram illustrating the DSC algorithm published by the VESA.

Referring to FIG. 1A and FIG. 1B, the DSC algorithm includes various operations such as prediction, quantization, reconstruction, ICH (Index Colored History), and rate control. Thus, the DSC algorithm has high calculation complexity, and requires a long time to compress an image.

Therefore, during a process of compressing and transmitting a high-resolution image, a DSC encoding operation may cause a bottleneck phenomenon.

The advantages and characteristics of the present disclosure and a method for achieving the advantages and characteristics will be clearly described through the following embodiments with reference to the accompanying drawings. However, the present disclosure is not limited to the following embodiments, but may be implemented in various shapes different from each other, and the following embodiments are only provided to easily deliver the purposes, configurations and effects of the present disclosure to those skilled in the art to which the present disclosure pertains. Therefore, the scope of the present disclosure is defined by claims.

Terms used in this specification are used for describing exemplary embodiments while not limiting the present invention. The terms of a singular form may include plural forms unless referred to the contrary. The meaning of ‘comprise’ and ‘comprising’ used in the specification specifies a component, step, operation, and/or element but does not exclude the presence or addition of other components, steps, operations, and/or elements. Throughout the specification, like reference numerals represent the same components, and the term “and/or” includes each of mentioned components and one or more combinations thereof. Although terms “first” and “second” are used to describe various components, the components are not limited by the terms. The terms are used only to distinguish one element from another element. Therefore, a first component described below may be a second component within the technical idea of the present disclosure.

Unless defined differently, all terms (including technical and scientific terms) used in this specification may be used as meanings which are commonly understood by those skilled in the art to which the present disclosure pertains. Furthermore, the terms which are defined in a generally used dictionary are not ideally or excessively construed unless clearly and specifically defined.

The present disclosure relates to an encoding system and method for DSC (Display Stream Compression).

The present disclosure is directed to a hardware device capable of performing video coding and compression, and more particularly, to a hardware device capable of processing a display link operation such as DSC at high speed.

Hereafter, a DSC encoding system 100 in accordance with an embodiment of the present disclosure will be described with reference to the accompanying drawings.

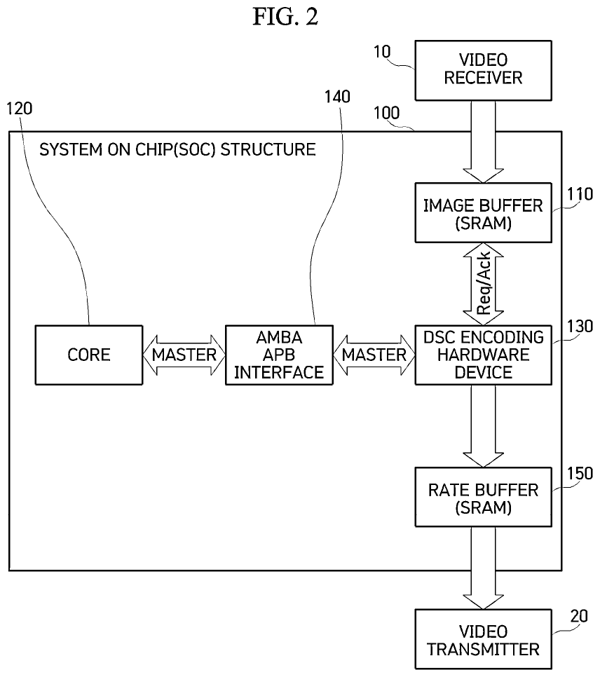

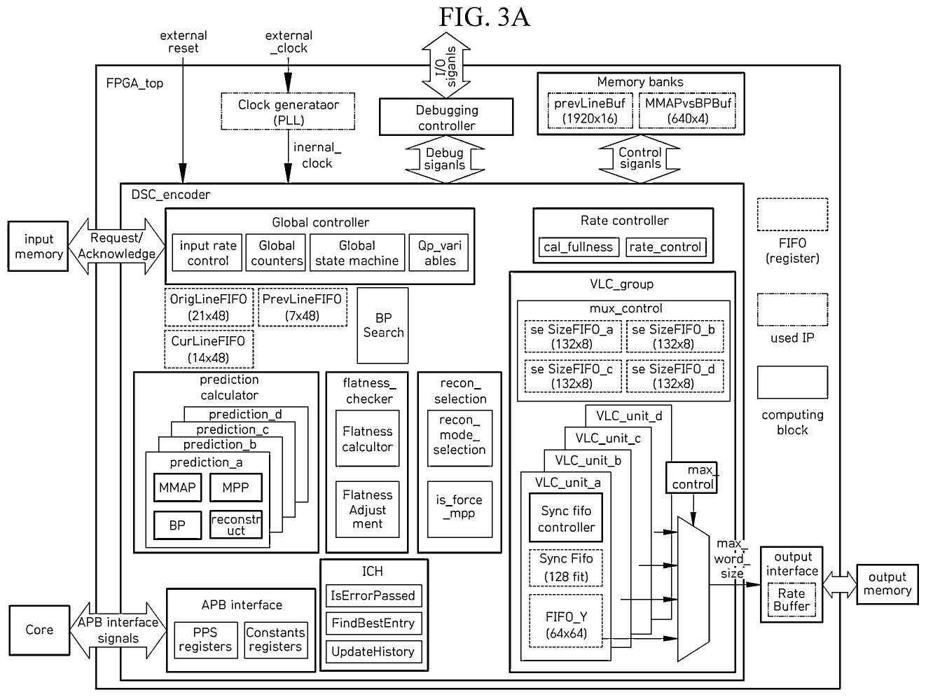

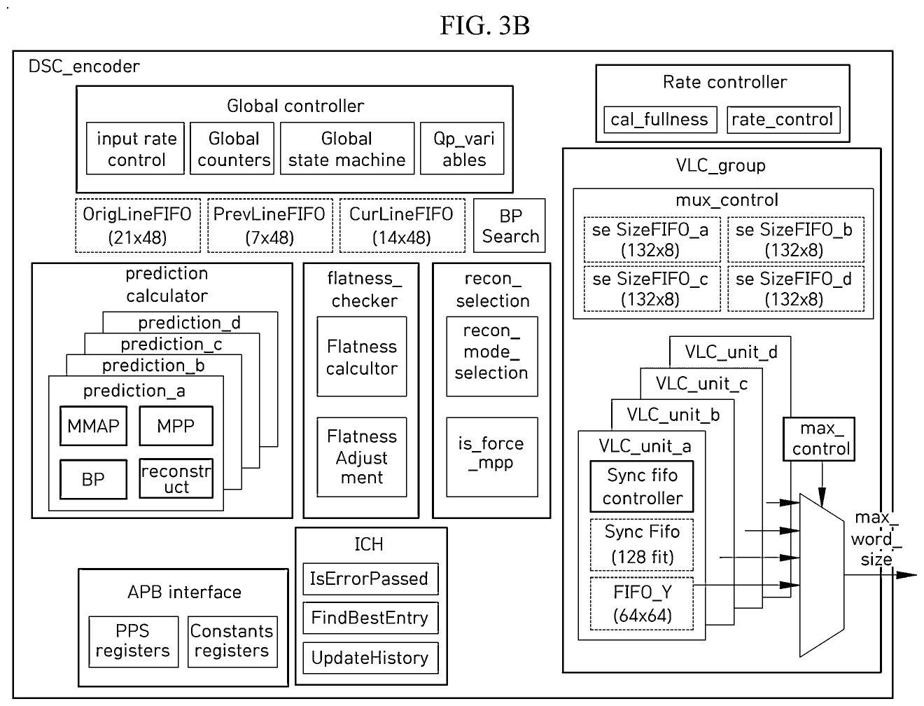

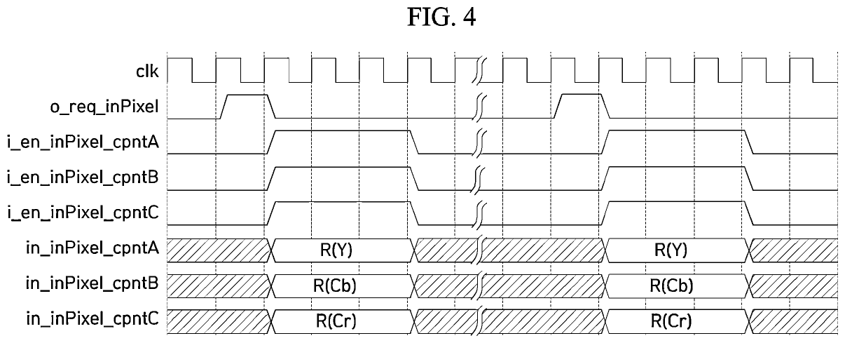

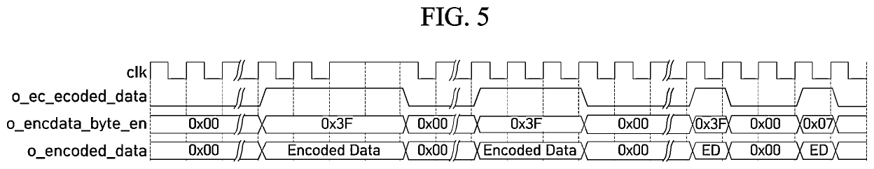

FIG. 2 is a block diagram illustrating a DSC encoding system 100 in accordance with an embodiment of the present disclosure. FIG. 3A and FIG. 3B are block diagrams illustrating a DSC encoding hardware device 130. FIGS. 4 and 5 are diagrams illustrating input/output timings of the DSC encoding hardware device 130.

The DSC encoding system 100 in accordance with the embodiment of the present disclosure includes an image buffer 110, a core 120, a DSC encoding hardware device 130 and a rate buffer 150.

The image buffer 110 stores an input video received through a video receiver 10. The input video may include one or more images. Each of the images is a still image forming a part of the video. In some cases, an image may be referred to as a video ‘frame’.

The core 120 sets and transfers a DSC encoding setting variable which is a value related to a DSC encoding operation of the DSC encoding hardware device 130.

As the DSC encoding hardware device 130 receives a DSC encoding operation execution command from the core 120, the DSC encoding hardware device 130 accesses the image buffer 110 and reads an input video stored in the image buffer 110.

At this time, the DSC encoding hardware device 130 accesses the image buffer 110 and reads the input video, at timings illustrated in FIG. 4.

Then, the DSC encoding hardware device 130 executes a DSC encoding operation on the basis of the DSC encoding setting variable. The DSC encoding hardware device 130 may generate a bit stream when encoding the input video. The bit stream may include a sequence of bits forming a coded expression of video data. The bit stream may include coded images and related data.

At this time, the core 120 and the DSC encoding hardware device 130 are connected to each other through an APB interface 140.

Referring to FIG. 3A and FIG. 3B, the DSC encoding hardware device 130 includes a global controller, a prediction calculator, an ICH, a flatness checker, a reconstruction selector, a VLC group, a rate controller, an APB interface, and a memory buffer.

In an embodiment, the DSC encoding hardware device 130 supports one or more input modes among RGB, YUV, YUV-422 and YUV-420.

Referring back to FIG. 2, the rate buffer 150 stores a DSC encoding result. As the DSC encoding operation is completed, the rate buffer 150 stores the bit stream outputted at timings illustrated in FIG. 5.

The bit stream stored in such a manner is read by a video transmitter, and outputted to a video device.

For reference, the components illustrated in FIGS. 2 and 3 in accordance with the embodiment of the present disclosure may be implemented in software or as a hardware module such as an FPGA (Field Programmable Gate Array) or ASIC (Application Specific Integrated Circuit), and may play predetermined roles.

However, ‘components’ are not limited to software or hardware, but may be configured in an addressable storage medium, or configured to activate one or more processors.

Therefore, examples of the component includes not only software components, object-oriented software components, class components, and task components, but also processes, functions, attributes, procedures, subroutines, segments of a program code, drivers, firmware, micro codes, circuits, data, database, data structures, tables, arrays and variables.

Components and functions provided within the corresponding components may be combined into fewer components or further separated into additional components.

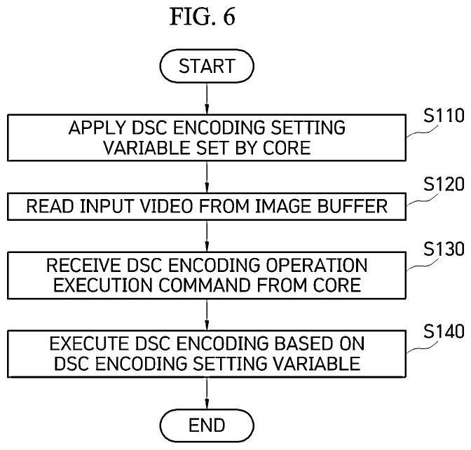

Hereafter, a method performed by the DSC encoding system 100 in accordance with the embodiment of the present disclosure will be described with reference to FIG. 6.

FIG. 6 is a flowchart illustrating a DSC encoding method in accordance with an embodiment of the present disclosure.

It may be understood that steps illustrated in FIG. 6 are performed by the DSC encoding hardware device of the DSC encoding system 100, but the present disclosure is not necessarily limited thereto.

First, the DSC encoding hardware device applies a DSC encoding setting variable set by the core in step S110. The DSC encoding hardware device and the core are connected to each other through the ABP interface.

Then, the DSC encoding hardware device reads an input video from the image buffer in which the input video received through the video receiver is stored, in step S120. In an embodiment, the DSC encoding hardware device supports one or more input modes among RGB, YUV, YUV-422 and YUV-420.

Then, when receiving a DSC encoding operation execution command from the core in step S130, the DSC encoding hardware device executes a DSC encoding operation on the basis of the DSC encoding setting variable, in step S140.

A bit stream which is outputted as the DSC encoding operation is completed is stored in the rate buffer. Thus, the video transmitter reads the bit stream stored in the rate buffer, and outputs the read bit stream to the video device.

In the above descriptions, steps S110, S120, S130 and S140 may be further divided into additional steps or combined into fewer steps, in different implementations. Furthermore, some steps may be omitted, if necessary, and the order of the steps may be changed. Furthermore, although the contents of some steps are omitted, the contents described with reference to FIGS. 2 to 5 are also applied to the DSC encoding method of FIG. 6.

The above-described DSC encoding method in accordance with the embodiment of the present disclosure may be implemented as a program (or application) and stored in a medium, so as to be executed through a server as hardware which is coupled thereto.

The above-described program may include codes written by a computer language such as C, C++, JAVA or machine language, which can be read by a processor (CPU) of a computer through a device interface of the computer, in order to execute the above-described method which is implemented as a program read by the computer. Such codes may include a functional code related to a function defining functions required for executing the above-described methods, and include an execution procedure-related control code required for the processor of the computer to execute the functions according to a predetermined procedure. Furthermore, such codes may further include additional information required for the processor of the computer to execute the functions or a memory reference-related code indicating the position (address) of an internal or external memory of the computer, where a medium needs to be referred to. Furthermore, when the processor of the computer needs to communicate with another remote computer or server in order to execute the functions, the codes may further include communication-related codes indicating how to communicate with another remote computer or server by using a communication module of the computer and which information or media to transmit/receive during communication.

The storage medium does not indicate a medium such as a register, cache or memory, which stores data for a short moment, but indicates a medium which semi-permanently stores data and can be read by a device. Specifically, examples of the storage medium include a ROM, RAM, CD-ROM, magnetic tape, floppy disk, optical data storage device and the like, but are not limited thereto. That is, the program may be stored in various recording media on various servers which the computer can access or various recording media of a user's computer. Furthermore, the media may store codes which can be distributed in computer systems connected through a network, and read by computers in a distributed manner.

The steps of the method or algorithm described in relation to the embodiment of the present disclosure may be directly implemented in hardware, implemented as a software module executed by hardware, or implemented by a combination thereof. The software module may reside in a RAM (Random Access Memory), ROM (Read Only Memory), EPROM (Erasable Programmable ROM), EEPROM (Electrically Erasable and Programmable ROM), flash memory, hard disk, detachable disk, CD-ROM, or a random computer-readable recording medium which is well known to the art to which the present disclosure pertains.

What is claimed is:

1. A display stream compression (DSC) encoding method in a DSC encoding hardware device, comprising:
applying a DSC encoding setting variable set by a core;
reading an input video, received through a video receiver, from an image buffer in which the input video is stored;
receiving a DSC encoding operation execution command from the core; and
executing a DSC encoding operation on the basis of the DSC encoding setting variable.

2. The DSC encoding method of claim 1, wherein the DSC encoding hardware device is connected to the core through an ABP interface.

3. The DSC encoding method of claim 1, wherein a bit stream, outputted as the DSC encoding operation is completed, is stored in a rate buffer, and
wherein a video transmitter reads the bit stream stored in the rate buffer, and outputs the read bit stream to a video device.

4. The DSC encoding method of claim 1, wherein the DSC encoding hardware device supports one or more input modes among RGB, YUV, YUV-422, or YUV-420.

5. A display stream compression (DSC) encoding system comprising:
an image buffer configured to store an input video received through a video receiver;
a core configured to set a DSC encoding setting variable;
a DSC encoding hardware device configured to read the input video from the image buffer according to a DSC encoding operation execution command received from the core, and execute a DSC encoding operation on the basis of the DSC encoding setting variable; and
a rate buffer configured to store an execution result of the DSC encoding operation.

6. The DSC encoding system of claim 5, wherein the DSC encoding hardware device is connected to the core through an ABP interface.

7. The DSC encoding system of claim 5, wherein the rate buffer is configured to store a bit stream which is outputted as the DSC encoding operation is completed, and
a video transmitter configured to read the bit stream stored in the rate buffer, and output the read bit stream to a video device.

8. The DSC encoding system of claim 5, wherein the DSC encoding hardware device is configured to support one or more input modes among RGB, YUV, YUV-422, or YUV-420.
